(19) United States
(12) Patent Application Publication
(10) Pub. No.: US 2012/0085430 A1
(43) Pub. Date: Apr. 12, 2012

(54) Pump Nozzle With Balloon-Tying Element

(76) Inventors: Paul J. Johansson, Fort Lauderdale, FL (US); Paul David Johansson, Fort Lauderdale, FL (US)

(21) Appl. No.: 12/899,821

(22) Filed: Oct. 7, 2010

(51) Int. Cl. F16K 15/20; A62C 31/02

(52) U.S. Cl. 137/231; 289/17; 239/589; 289/1.5

(57) ABSTRACT

A device and method for sealing an inflated balloon includes providing a balloon-tying pump nozzle that has an air nozzle defining an air passageway adapted for communicating air between an air-collection chamber of an air pump and the environment and a balloon-neck-engaging extension adjacent to and extending substantially parallel to the air nozzle, the balloon-neck-engaging extension defining a channel between the balloon-neck-engaging extension and the air nozzle, wherein the channel is sized to accept a neck of a standard party balloon therein while inhibiting a lip of the standard party balloon from passing therebetween. The method further includes the steps of placing a neck of a balloon adjacent the air nozzle and the balloon-neck-engaging extension so that the balloon is on a first side of the air nozzle and the balloon-neck-engaging extension, securing a portion of the neck of the balloon with reference to the air nozzle, manipulating the balloon so that at least a portion of the neck of the balloon is wrapped completely around both the air nozzle and the balloon-neck-engaging extension, inserting a portion of the neck within the channel so that the lip of the balloon is on a second side of the air nozzle and the balloon-neck-engaging extension, and removing the balloon from both the balloon-neck-engaging extension and the air nozzle, thereby causing the balloon to form a knot.

### FIELD OF THE INVENTION

The present invention relates generally to nozzles for air pumps, and more particularly relates to a nozzle for an air pump that provides a balloon-tying element.

### BACKGROUND OF THE INVENTION

A balloon is an inflatable flexible skin filled with a type of gas, such as helium, air or others, and shaped to contain the gas within its interior. The gas placed within the skin and composition of the skin varies greatly depending on the intended use of the balloon. For instance, balloons that are purely decorative, commonly referred to as “party balloons,” can be made of a low-cost, low-durability material and are generally filled with either air, helium, or hydrogen. In contrast, balloons that are used for specific purposes, such as meteorology, medical treatment, military defense, or transportation use more sophisticated, higher-cost materials to form their skin.

Balloon artists are entertainers who twist and tie inflated tubular balloons into balloon animals and other twisted balloon sculptures and can often be found working as clowns or restaurant entertainers. These artists commonly refer to themselves as “twisters.” The term “twister,” as used herein, will refer to both professionals and non-professional balloon inflators.

Balloon sizes are usually identified by a number: the most common size of twisting balloons is called a “260,” as it is approximately two inches in diameter and sixty inches in length. Thus, a “260” is 2×60 inches. Similarly, a “160” is 1×60 inches when fully blown up. Although these are the most common sizes used, there are dozens of other shapes available as well.

For many years, the standard practice of twisters was to inflate the balloons with their own lungs. However, most now use a mechanical pump of some sort, whether it is a hand pump, an electric pump, or a tank of compressed gas. There are several reasons for this transition from mouth-inflation to pump-inflation. First, most twisters are physically incapable of mouth-inflating, as their job requires them to inflate hundreds of balloons during any single performance. The balloons used for balloon sculpture are made of very strong rubber so that they can be twisted and tied without bursting. Since the pressure required to inflate a balloon is inversely proportional to the diameter of the balloon, these tiny tubular balloons are extremely hard to inflate by mouth. This is particularly true for the 160s, which are much more difficult to mouth-inflate than the more common 260s, as their narrowness requires a great deal more strength and breath pressure to inflate.

Second, blowing up balloons by mouth exposes the twister to multiple potential health risks. These include lightheadedness or fainting, due to the pressure and rapid exhaling. In addition, eye injuries can result from a balloon popping and snapping back toward the twister's eyes while it is being blown up. In rare cases, the pressure can damage the ears, eye, or the muscles around the throat.

A third reason for using a hand pump relates to hygienic issues. Many twisters and parents are uncomfortable handing a child something that has been in the twister's (or anyone's) mouth.

Finally, because balloons pose a choking hazard for small children, many twisters prefer to avoid being a bad role model by putting a balloon in their mouths around children.

Air pumps known in the art include three basic elements: 1) an air chamber; 2) a mechanical activator for causing air to enter and exit the air chamber; and 3) a cylindrical nozzle, upon which a neck of the balloon is placed and secured while the air within the chamber exits through the nozzle and into the balloon. These pumps work well for inflating the balloons quickly and easily. However, once the balloon is inflated, the twister must then seal the neck of the balloon so that the air within is not able to escape. Of course, the most common method of sealing the opening, i.e., the neck of the balloon, is by tying it in a knot. This requires the balloon to be separated from the pump nozzle, the pump to be stowed away (because tying requires the availability of both hands), and for the twister to manipulate the neck of the balloon into a knot. It is not only clumsy and inconvenient to repeatedly have to pick up and put away the pump, but also tying hundreds of balloons in a session can cause skin wear and pressure-induced pain to the twister.

Prior-art devices designed to assist the twister in tying the neck of the balloon mainly consist of nozzles with a split down the center, bisecting the nozzle into two halves (usually symmetric). The split can then be used to secure the neck while other portions of the balloon are manipulated by the twister's hand. However, dividing the normally smooth, cylindrical nozzle into multiple parts provides areas that catch the neck of the balloon and make it more difficult to slip over the nozzle prior to inflation.

Other devices designed for assistance with balloon tying are separate devices, which are not associated with or coupled to the pump used to inflate the balloon. While these devices claim to reduce the wear on the twister's hands, they require an additional item to keep track of as well as the additional separate step of alternating between holding the device and the pump.

Therefore, a need exists to overcome the problems with the prior art as discussed above.

### SUMMARY OF THE INVENTION

The invention provides a pump nozzle with a balloon-tying element that overcomes the hereinafore-mentioned disadvantages of the heretofore-known devices and methods of this general type and that allows a user to utilize a hand pump to inflate a balloon and also use the same pump to facilitate tying a knot in the neck of the balloon without having to substantially alter pump's position within the user's hand.

With the foregoing and other objects in view, there is provided, in accordance with the invention, a device and method for sealing an inflated balloon that includes providing a balloon-tying pump nozzle that has an air nozzle defining an air passageway adapted for communicating air between an air-collection chamber of an air pump and the environment and a balloon-neck-engaging extension adjacent to and extending substantially parallel to the air nozzle, the balloon-neck-engaging extension defining a channel between the balloon-neck-engaging extension and the air nozzle, wherein the channel is sized to accept a neck of a standard party balloon therein while inhibiting a lip of the standard party balloon from passing therebetween. The method further includes the steps of placing a neck of a balloon adjacent the air nozzle and the balloon-neck-engaging extension so that the balloon is on a first side of the air nozzle and the balloon-neck-engaging extension, securing a portion of the neck of the balloon with reference to the air nozzle, manipulating the balloon so that at least a portion of the neck of the balloon is wrapped completely around both the air nozzle and the balloon-neck-engaging extension, inserting a portion of the neck within the channel so that the lip of the balloon is on a second side of the air nozzle and the balloon-neck-engaging extension, and removing the balloon from both the balloon-neck-engaging extension and the air nozzle, thereby causing the balloon to form a knot.

In accordance with another feature, an embodiment of the neck-engaging extension of the present invention includes a first portion and a second portion, where the second portion is physically coupled to the first portion, located between the elongated pump nozzle and the first portion, and has a dimension that is less than a dimension of the first portion, thereby forming a balloon-lip-engagement compartment.

In accordance with a further feature of the present invention, a difference between the dimension of the first portion of the neck-engaging extension and the dimension of the second portion of the neck-engaging extension is at least substantially equal to a height dimension of a lip of a standard balloon.

In accordance with an additional feature of the present invention, the balloon-lip-engagement compartment is defined by the first portion of the neck-engaging extension, the second portion of the neck-engaging extension, and an outside surface of the elongated pump nozzle.

In accordance with a yet another feature of the present invention, the second portion of the neck-engaging extension is substantially centered upon the first portion of the neck-engaging extension, thereby defining the balloon-lip-engagement compartment on a first side of the second portion of the neck-engaging extension and a second balloon-lip-engagement compartment on a second side of the neck-engaging extension.

In accordance with one further feature of the present invention, the first portion of the neck-engaging extension defines an outer neck-wrapping peripheral surface.

In accordance with another feature, an embodiment of the present invention also includes an air pump having an air-collecting chamber, an air nozzle extending from and in fluid communication with an interior of the air-collecting chamber, and a balloon-neck-engaging extension adjacent the nozzle and physically coupled to at least one of the air collecting chamber and the nozzle, the balloon-neck-engaging extension and the nozzle forming a balloon neck-engaging channel therebetween, the balloon neck-engaging channel being sized to accept a neck of a standard party balloon therein while inhibiting a lip of the standard party balloon from passing therebetween.

In accordance with a further feature of the present invention, the balloon-neck-engaging extension further includes a first portion and a second portion physically coupled to each other, where the second portion is located between the air nozzle and the first portion and has a dimension that is less than a dimension of the first portion to form a balloon-lip-engagement compartment.

In accordance with the present invention, a method for sealing an inflated balloon includes the steps of providing a balloon-tying pump nozzle, placing a neck of a balloon adjacent the air nozzle and the balloon-neck-engaging extension so that the balloon is on a first side of the air nozzle and the balloon-neck-engaging extension, securing a portion of the neck of the balloon with reference to the air nozzle, manipulating the balloon so that at least a portion of the neck of the balloon is wrapped completely around both the air nozzle and the balloon-neck-engaging extension, inserting a portion of the neck within the channel so that the lip of the balloon is on a second side of the air nozzle and the balloon-neck-engaging extension, and removing the balloon from both the balloon-neck-engaging extension and the air nozzle, thereby causing the balloon to form a knot.

In accordance with yet another feature, the removing step includes pulling one of the neck and a body of the balloon away from the balloon-tying pump nozzle in a distal direction.

In accordance with a further feature of the present invention, the removing step includes placing a force upon a portion of the neck that rests upon an exterior surface of the balloon-neck-engaging extension in a distal direction.

Although the invention is illustrated and described herein as embodied in a pump nozzle with a balloon-tying element, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the air passageway of the nozzle.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a fragmentary, perspective view of a distal end of an air pump with an air-delivery nozzle and a balloon-tying element in accordance with the present invention;

FIG. 2 is a fragmentary, perspective view of a second side of the distal end of the air pump of FIG. 1 in accordance with the present invention;

FIG. 3 is a fragmentary, perspective view of the distal end of the air pump of FIG. 1 in accordance with the present invention;

FIG. 4 is a fragmentary, perspective view of the distal end of the air pump of FIG. 1 showing a smooth outer neck-wrapping peripheral surface of the balloon-tying element in accordance with the present invention;

FIG. 5 is a fragmentary, elevational view of the neck of a prior-art balloon.

FIG. 6 is a fragmentary, perspective downward-looking view of the distal end of the balloon-tying element in accordance with the present invention;

FIG. 7 is a fragmentary, perspective view of the distal end of the air pump of FIG. 1 in accordance with the present invention;

FIG. 8 is a fragmentary, elevational side view of the distal end of the air pump of FIG. 1 in accordance with the present invention;

FIG. 9 is a fragmentary, elevational side view of the distal end of the air pump of FIG. 1 in accordance with the present invention;

FIG. 10 is a fragmentary, elevational view of the distal end of the air pump of FIG. 1 showing a smooth outer neck-wrapping peripheral surface of the balloon-tying element in accordance with the present invention;

FIG. 11 is a fragmentary, elevational plan view of the distal end of the air pump of FIG. 1 in accordance with the present invention;

FIG. 12 is a fragmentary, perspective view of the distal end of the air pump of FIG. 1 in accordance with the present invention;

FIGS. 13-18 are fragmentary, perspective views of the distal end of the air pump of FIG. 1 illustrating steps of a balloon-tying process in accordance with the present invention;

FIG. 19 is a process flow diagram illustrating steps of the balloon-tying process illustrated in FIGS. 13-18 in accordance with the present invention;

FIG. 20 is an elevational side view of another exemplary embodiment of an air-delivery nozzle and a balloon-tying element in accordance with the present invention;

FIG. 21 is a perspective end view of the air-delivery nozzle and balloon-tying element of FIG. 20 in accordance with the present invention;

FIG. 22 is a perspective left-side view of a snap-on balloon-tying accessory in accordance with the present invention;

FIG. 23 is a perspective back-side view of the snap-on balloon-tying accessory of FIG. 22;

FIG. 24 is a perspective right-side view of the snap-on balloon-tying accessory of FIG. 22;

FIG. 25 is an elevational left-side view of the snap-on balloon-tying accessory of FIG. 22;

FIG. 26 is an elevational left-side view of the snap-on balloon-tying accessory of FIG. 22 removably coupled to an air-delivery nozzle in accordance with the present invention;

FIG. 27 is a perspective rear-side view of the removably coupled snap-on balloon-tying accessory and air-delivery nozzle of FIG. 26 in accordance with the present invention;

FIG. 28 is an elevational rear-side view of the removably coupled snap-on balloon-tying accessory and air-delivery nozzle of FIG. 26 in accordance with the present invention;

FIG. 29 is a planar downward-looking view of the removably coupled snap-on balloon-tying accessory and air-delivery nozzle of FIG. 26 in accordance with the present invention;

FIG. 30 is a perspective left-side view of the removably coupled snap-on balloon-tying accessory and air-delivery nozzle of FIG. 26 in accordance with the present invention

FIG. 31 is a perspective right-side view of a snap-on balloon-tying accessory in accordance with the present invention;

FIG. 32 is a perspective left-side view of the snap-on balloon-tying accessory of FIG. 31;

FIG. 33 is a perspective back-side view of the snap-on balloon-tying accessory of FIG. 31;

FIG. 34 is a perspective left-side view of the snap-on balloon-tying accessory of FIG. 31;

FIG. 35 is an elevational left-side view of the snap-on balloon-tying accessory of FIG. 31 removably coupled to an air-delivery nozzle in accordance with the present invention;

FIG. 36 is a planar downward-looking view of the removably coupled snap-on balloon-tying accessory and air-delivery nozzle of FIG. 35 in accordance with the present invention;

FIG. 37 is a perspective side view of a snap-on balloon-tying accessory in accordance with the present invention; and

FIG. 38 is a perspective opposite-side view of the snap-on balloon-tying accessory of FIG. 37.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient nozzle for air pumps or other devices. Embodiments of the invention provide a longitudinally extending element parallel and adjacent to a nozzle shaped to communicate air. The inventive element is useful for assisting a user in tying the neck of a balloon in a knot.

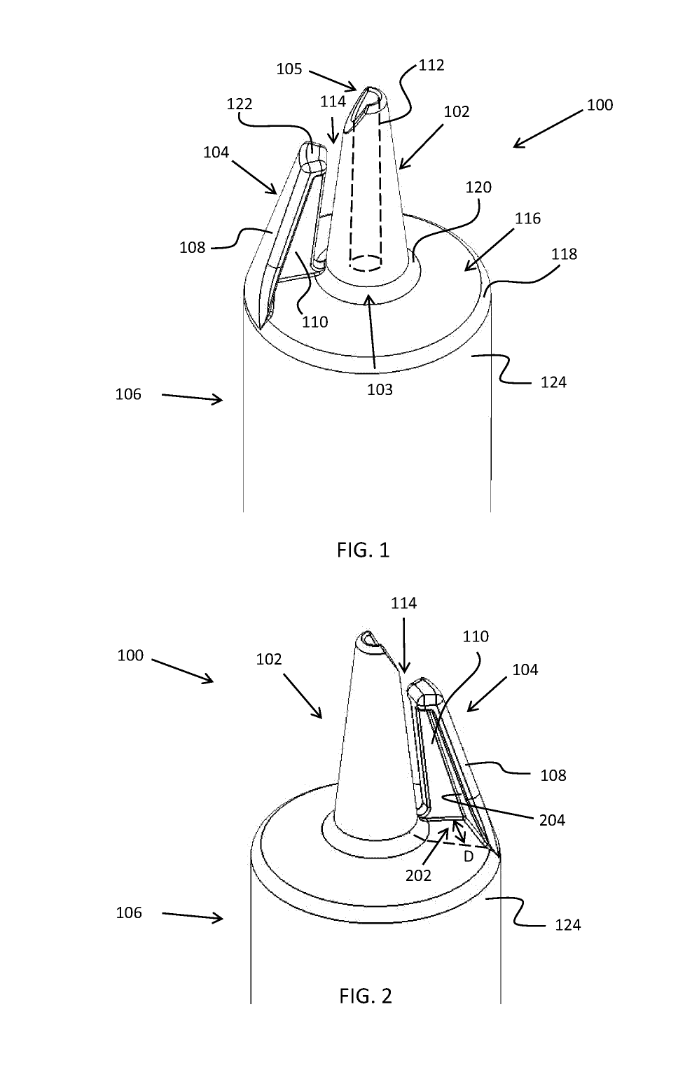

Referring now to FIG. 1, one embodiment of the present invention is shown in a perspective end view. FIG. 1 shows several advantageous features of the present invention, but, as will be described below, the invention can be provided in several shapes, sizes, combinations of features and components, and varying numbers and functions of the components. The first example of a balloon-tying pump 100, as shown in FIG. 1, includes an elongated pump nozzle 102 defining an air passageway 112 adapted for transporting air between an air-collection chamber 106 of the air pump 100 to the environment. The air-collection chamber 106 is the portion of the air pump 100 that pulls in air from the surrounding environment when a vacuum is placed on the air-collection chamber 106. The vacuum is usually the result of a non-illustrated plunger moving within the air-collection chamber 106 in a first direction. However, when the non-illustrated plunger is moved in a second direction (opposite the first direction), air is then forced out of the air-collection chamber 106 and exits through the air passageway 112. It should be noted that the present invention pertains to a novel balloon-tying nozzle which can be attached to many different kinds of air pumps or other devices. Therefore, the air-collection chamber 106 is not a necessary component of the present invention.

By placing the elongated pump nozzle 102 within the neck of a balloon, air that exits the air-collection chamber 106 through the air passageway 112 is directed into and is contained by the balloon. By holding the neck of the balloon tightly against the pump nozzle 102, a great deal of positive pressure can be placed within the interior of the balloon's skin, causing the balloon to expand.

As FIG. 1 shows, the elongated pump nozzle 102 has a general conical shape. That is, the outer diameter of the elongated pump nozzle 102 increases from a distal-most point 105 furthest away from the air-collection chamber 106 to a proximal point 103, where the pump nozzle 102 is joined to the air-collection chamber 106. Although a conical shape is in no way required by the present invention, the increasing outer diameter of the conical elongated pump nozzle 102 is useful for maintaining an airtight seal between a balloon and the outer surface of the nozzle 102. The increasing outer diameter of the elongated pump nozzle 102 is also useful allowing balloons of multiple sizes to be inflated with the present invention.

The proximal end 105 of the pump nozzle 102 is coupled to a distal end 116 of the air-collection chamber 106. A chamfer 120 provides a smooth transition between the pump nozzle 102 and the distal end 116 of the air-collection chamber 106. A second chamfer 118 provides a smooth transition between the distal end 116 of the air-collection chamber 106 and a cylindrical sidewall 124 of the air collection chamber 106. The chamfers 118, 120 provide aesthetics as well as an overall reduction of sharp edges that could damage the skin of balloons that come in contact with them. Of course, chamfers 118, 120 are not necessary to carry out the present invention.

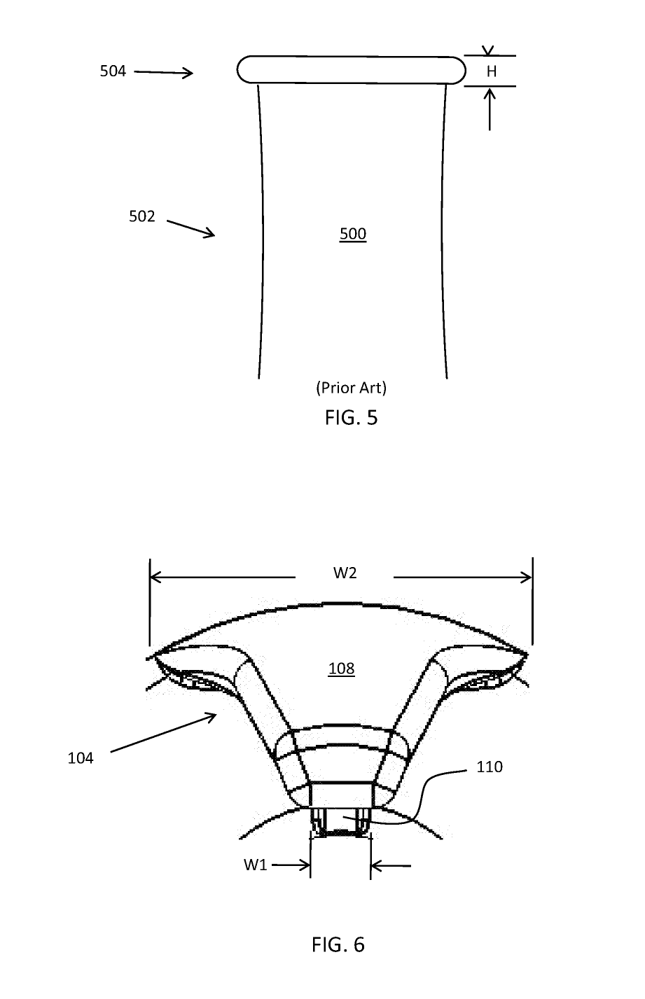

FIG. 1 also shows an inventive neck-engaging extension 104 adjacent to the elongated nozzle 102. The neck-engaging extension 104 extends in a direction that is substantially parallel to the elongated nozzle 102 with a channel 114 there between. As will be explained in greater detail below, the channel 114, defined by the neck-engaging extension 104 and the elongated nozzle 102, is of sufficient size to allow a neck 502 of a balloon 500, shown in FIG. 5, to fit within the channel 114, but small enough to inhibit a lip 504 of the balloon 500 from passing from one to the other side thereof. The term “inhibit,” as used herein, is intended to mean a resistance of the lip 504 from passing through the channel 114. The term “inhibit” is not intended to mean that the lip 504 of the balloon 500 cannot be forced through the channel 114 if enough force is applied. However, in normal use, where the anticipated tension on the body of the balloon is no more than what is reasonably anticipated for a typical knot-tying process, the lip 504 will stay on one side of the channel 114 during the knot-tying process.

It should be noted that, while typical party balloons have a well-defined neck and body, balloons used for twisting into balloon sculptures are generally cylindrical along their length and do not have a distinct neck/body transition. As used herein, the “neck” of the balloon indicates both a neck portion and a body portion.

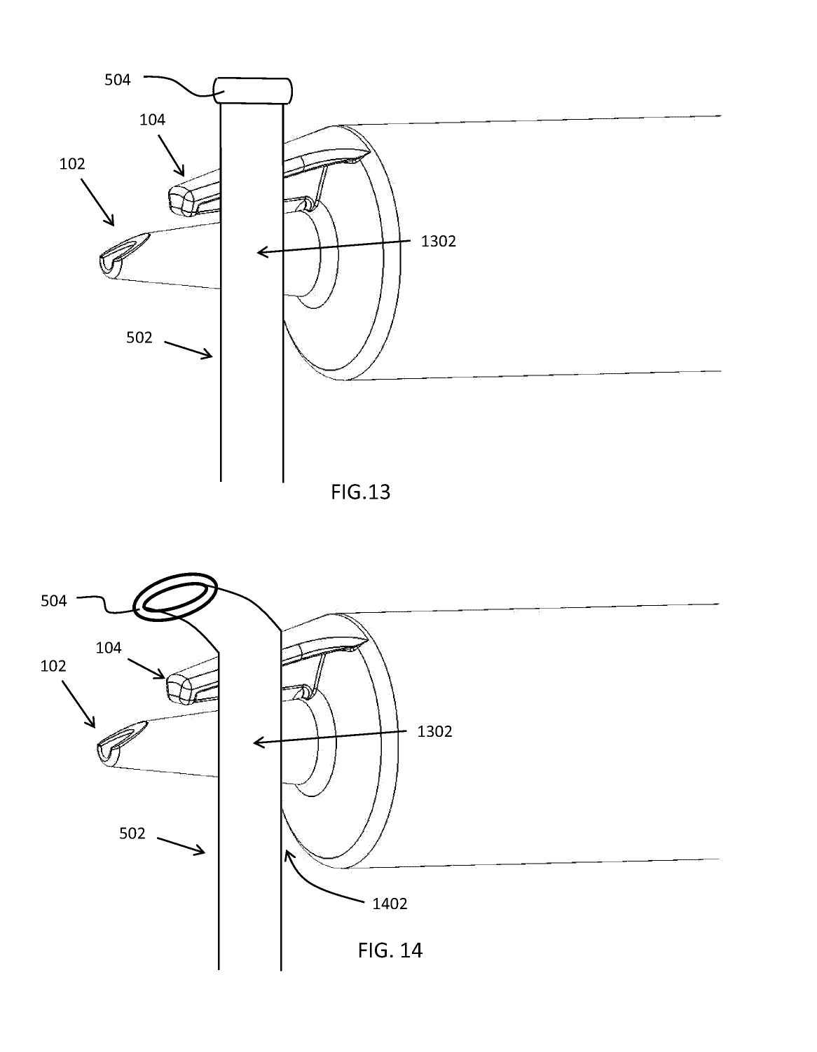

With reference still to the perspective view of FIG. 1, it can be seen that the neck-engaging extension 104 has a particular shape that is conducive to holding a balloon during tying. This shape is defined, in the embodiment shown in FIG. 1, by a first portion 108 and a second portion 110 that is physically coupled to the first portion 108 in a T-type configuration, where the second portion 110 is disposed between the elongated pump nozzle 102 and the first portion 108. Referring briefly to FIG. 6, the downward perspective view shows that the second portion 110 has a width W1 that is less than a width W2 of the first portion 108. Moving now to FIG. 2, the imaginary dotted line illustrates that the differences in width between the first portion 108 and the second portion 110 of the neck-engaging extension 104 forms a recessed lip engagement compartment 202 at least on one side of the second portion 110. As will be explained in detail below, in particular with reference to FIGS. 13-19, the recessed lip engagement compartment 202 allows the neck 502 of a balloon 500 to slide over the lip of 504 of the balloon 500 during the tying process and also temporarily secures the lip 504 of the balloon 500 as the balloon 500 is finally removed from the pump 100, thereby providing a tight, secure knot.

In accordance with an embodiment of the present invention, a height H of the lip 504 of a balloon, shown in FIG. 5, is substantially equal to or less than a distance D between the imaginary dotted line and a surface of the second portion 110 of the neck-engaging extension 104. Because the recessed lip engagement compartment 202 is sized to accept the height H of the lip 504 of a balloon, the recessed lip engagement compartment 202 is able to secure the lip 504 of a balloon during a knot-tying step of the balloon's inflation process. More specifically, a difference between the width W2 of the first portion 108 of the neck-engaging extension 104 and the width W1 of the second portion 110 of the neck-engaging extension 104 is at least substantially equal to the height dimension H of the lip 504 of a standard party balloon. It is this width difference (W2-W1) that provides the recessed lip engagement compartment 202.

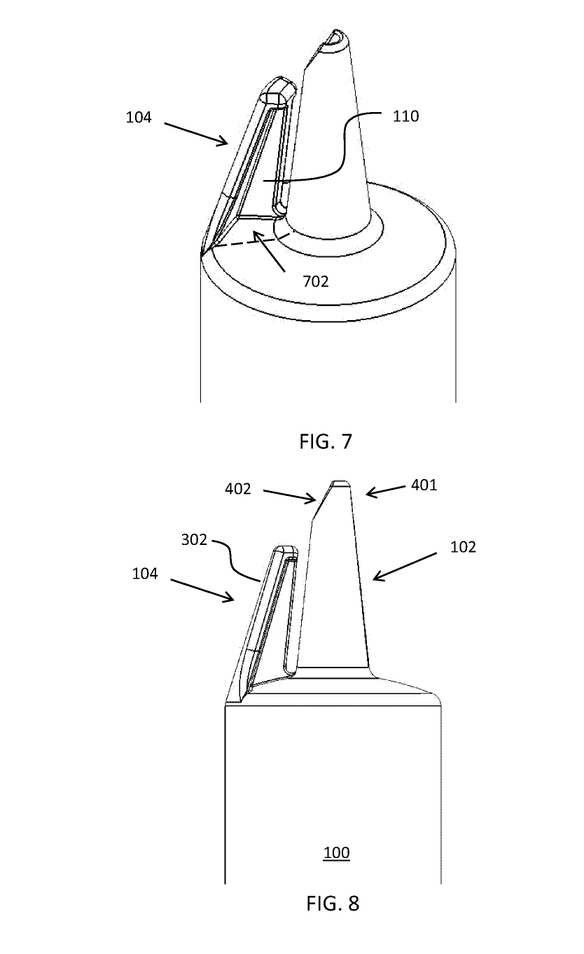

As the figures show, the first portion 108 of the neck-engaging extension 104 is, in an embodiment of the present invention, substantially centered upon the second portion 110 of the neck-engaging extension 104. This centering advantageously defines the recessed lip engagement compartment 202 on a first side of the second portion 110 of the neck-engaging extension 104, shown in FIG. 2, as well as a second lip engagement channel 702 on a second side of the neck-engaging extension 104, shown in FIG. 7. Providing a recessed lip engagement compartment on both sides of the second portion 110 allows the knot-tying process to be performed equally as well with the user's right and left hand.

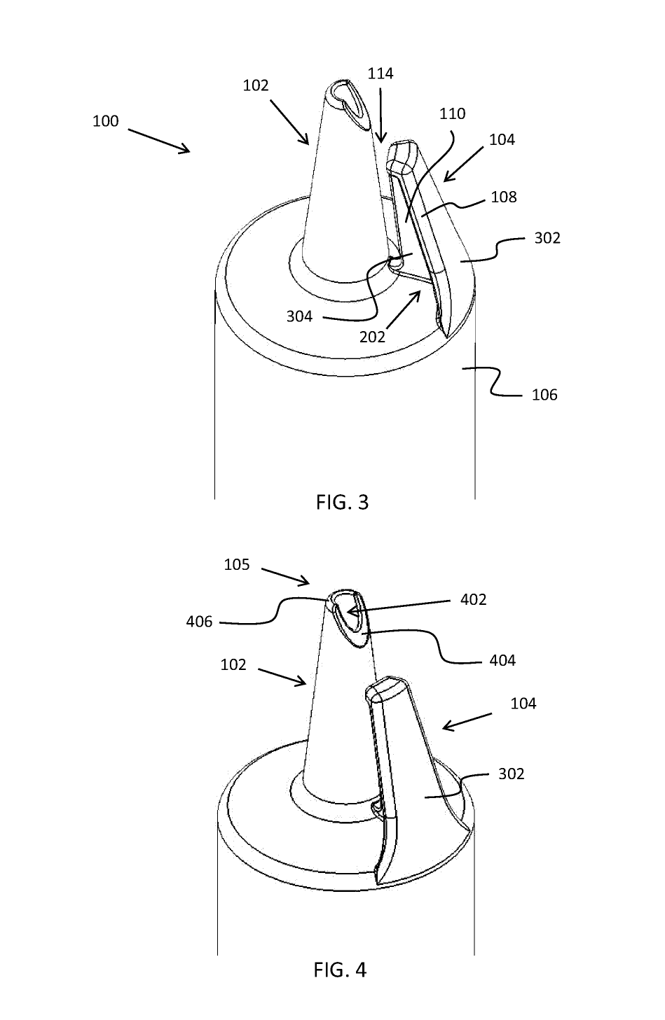

Referring now to FIG. 3, the perspective downward-looking view of the neck-engaging extension 104 shows an outer neck-wrapping peripheral surface 302 of the neck-engaging extension 104. Embodiments of the present invention provide chamfers, or rounded/smooth edges on all surfaces when practical. These smooth transitions between surfaces minimize damage to the flexible material of the balloon when it is in physical contact with the pump 100, i.e., while it is being inflated and tied. In addition, the pump 100 and balloons may be stored in the same compartment. Reducing or eliminating sharp edges and points of the pump 100 prevents damage to the balloons anytime the pump 100 comes in contact with them. As will be described below, during the tying process, the balloon is wrapped around the neck-wrapping peripheral surface 302. Forming the peripheral surface 302 with a smooth outer surface minimizes the potential of damage to the balloon.

Perhaps an exception to this rounded-surface rule is the second portion 110 of the neck-engaging extension 104. As FIGS. 1-3 show, the second portion 110 of the neck-engaging extension 104 provides at least one planar lip supporting surface 304, labeled in FIG. 3. This planar lip supporting surface 304 is useful for blocking and preventing the lip 504 of the balloon 500 from fitting through the channel 114 when the neck 502 of the balloon 500 is placed within the channel 114 and tension is placed on the neck 502 of the balloon biasing the lip 504 toward the channel 114. This feature is explained below and shown in greater detail in connection with FIGS. 13-19.

Referring now to FIG. 4, an additional feature of the present invention is illustrated. The perspective downward looking view of FIG. 4 shows a chamfer 402 at the distal end 105 of the nozzle 102. The chamfer 402 provides a smooth surface 404 at an angle towards the neck-engaging extension 104. The chamfer 402 also reduces the size of the overall outer dimension of the distal end 401 of the nozzle 102, making it easier to insert the distal end 105 of the nozzle 102 into a mouth of a balloon. The chamfer 402 also makes it easier to slide a balloon off of the nozzle 102 after inflation and tying. In addition, a rounded edge 406 is provided on the distal end of the nozzle 102. The rounded edge 406 reduces and/or eliminates any surfaces/edges that could puncture or otherwise damage the balloon during insertion over the nozzle 102.

FIG. 8 provides an elevational side view of the inventive knot-tying pump 100 in accordance with an embodiment of the present invention. From the elevational view of FIG. 8, the chamfer 402 can be seen as providing an angle in a direction toward (or away from) the neck-engaging extension 104. As will be described below, once a balloon is properly manipulated around the neck-engaging extension 104, it will be removed by sliding it along the smooth peripheral surface 302 of the neck-engaging extension 104, across the chamfer 402, and away from the inventive pump nozzle 102. Although not necessary for practicing the present invention, the angles of the smooth peripheral surface 302 of the neck-engaging extension 104 and the chamfer 402 of the nozzle 102 provides quick and easy removal of a balloon from the inventive device resulting in a knot at the neck of a balloon.

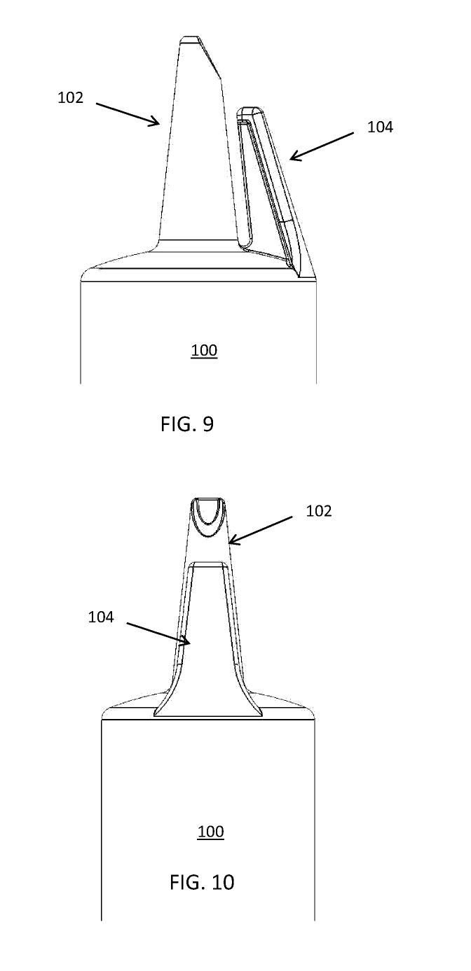

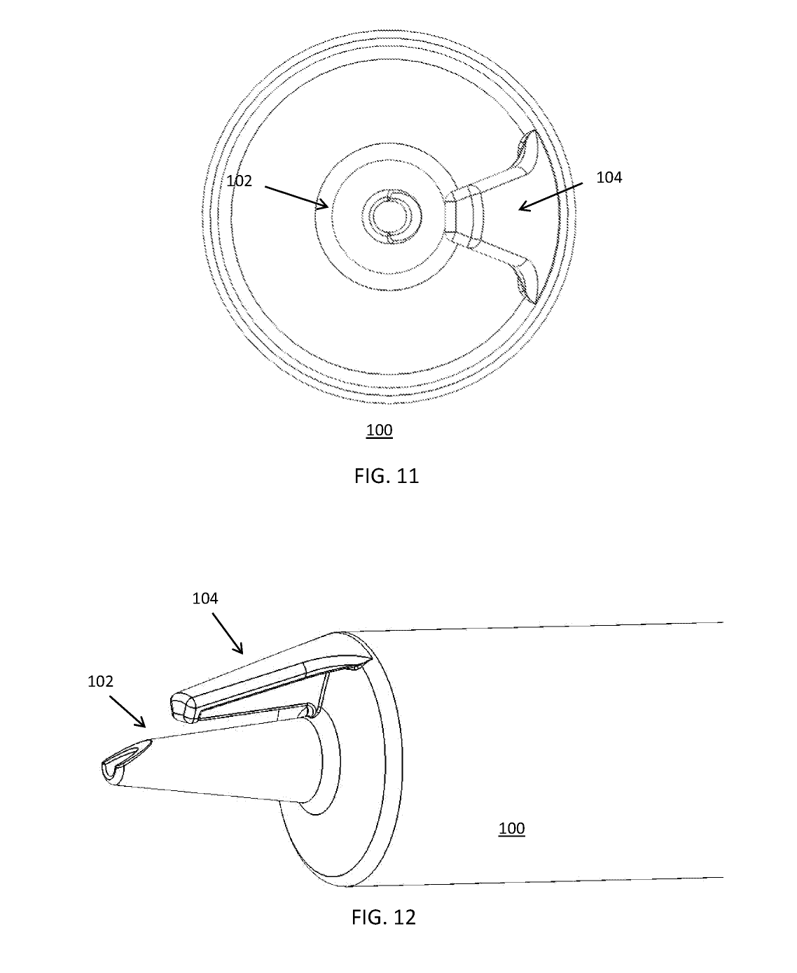

FIGS. 9-12 provide additional views of the inventive knot-tying pump 100 in accordance with an embodiment of the present invention.

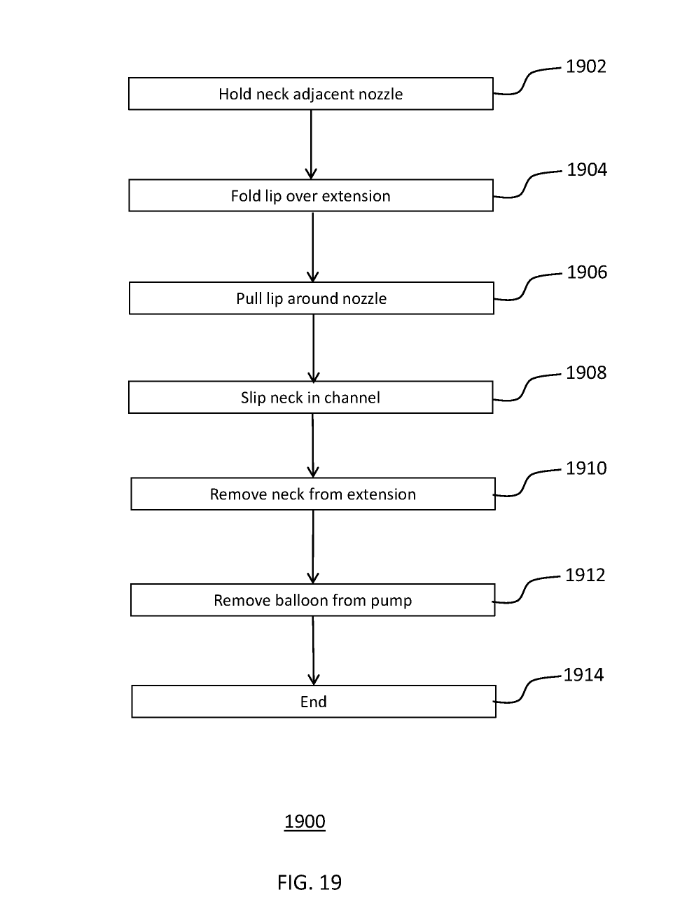

FIGS. 13-18 provide an illustrative representation of steps that are part of an inventive method for tying a knot in a balloon, each of the steps utilizing an embodiment of the present invention. This inventive method 1900 is also shown in the process flow diagram of FIG. 19. In a first step 1902, shown in FIG. 13, the neck 502 of a balloon is held adjacent to both the nozzle 102 and the neck-engaging extension 104 so that the lip 504 extends slightly above the neck-engaging extension 104, with reference to the orientation shown in FIG. 13. It is envisioned that, at this step, a user will apply pressure with their thumb against the neck 502 of the balloon at a point 1302 so that it is pinched and held securely between the users thumb and the nozzle 102. For the orientation of the balloon and pump shown in FIG. 13, it will generally be the user's right-hand thumb that will secure the neck 502 to the nozzle 102. As stated above, however, one embodiment of the present invention provides a symmetrical neck-engagement extension 104 so that either hand can be used to perform the inventive method of tying a balloon in a knot.

In a second step 1904, shown in FIG. 14, the lip 504 is folded over the neck-engaging extension 104 so that the lip 504 is on a side of the neck-engaging extension 104 opposite the majority of the neck 502. As explained in the previous paragraph, the user will, for the orientation shown in FIGS. 13-18, generally be holding the pump with their right hand and securing the neck 502 of the balloon to the nozzle 102 with their right-hand thumb at location 1302. Therefore, to move the balloon lip 504 from the position shown in FIG. 13 to that shown in FIGS. 14-18, the user will reach under the pump (see arrow 1402) with their left hand and grasp lip 504 and pull it around the opposite side of the nozzle 102.

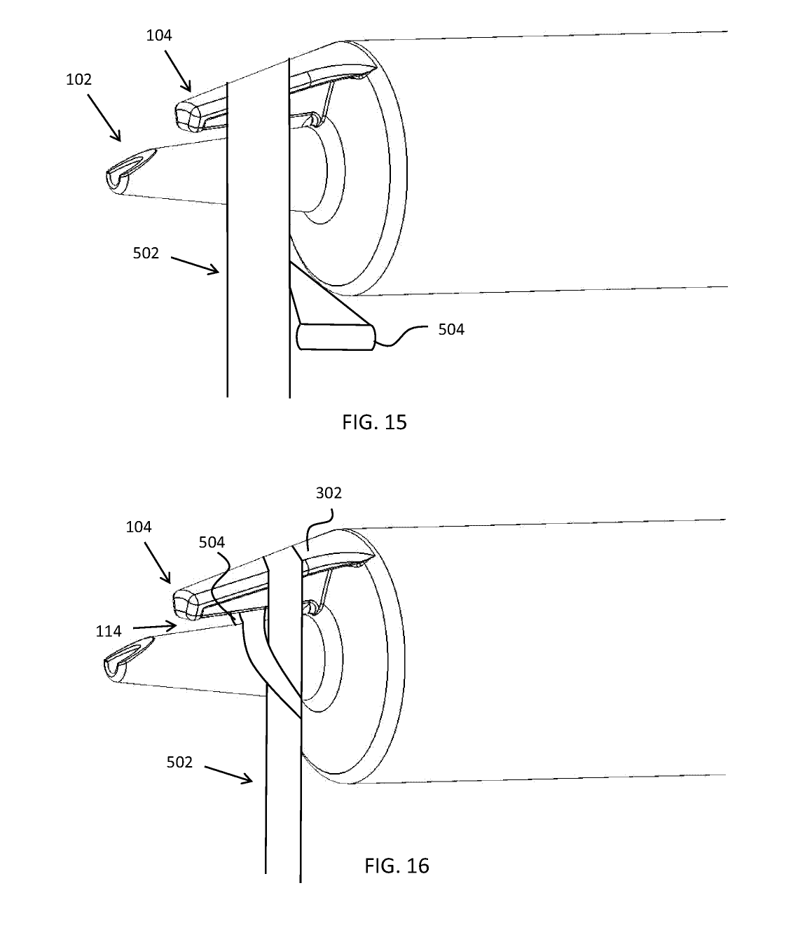

In a next step 1906, shown in FIG. 15, the user pulls the lip 504 around the nozzle 102 and back to the side of the nozzle 102 where the neck 502 is being secured by the user's thumb. The user then, in step 1908, shown in FIG. 16, pulls the lip 504 toward the distal end of the pump nozzle 102 until the lip 504 passes the channel 114. In this same step, a portion of the neck 502 is inserted within the channel 114 so that the lip 504 is on a side of the channel 114 opposite the users thumb and a majority of the balloon's body 502. Because the balloon is made of an elastic material, such as rubber, there will be an elastic force applying pressure to the lip 504 in a direction toward the channel 114. As explained above, in a preferred embodiment of the present invention, at least one dimension H of the lip 504 is greater than a height of the channel 114. Therefore, the lip 504 is prevented from sliding through the channel 114.

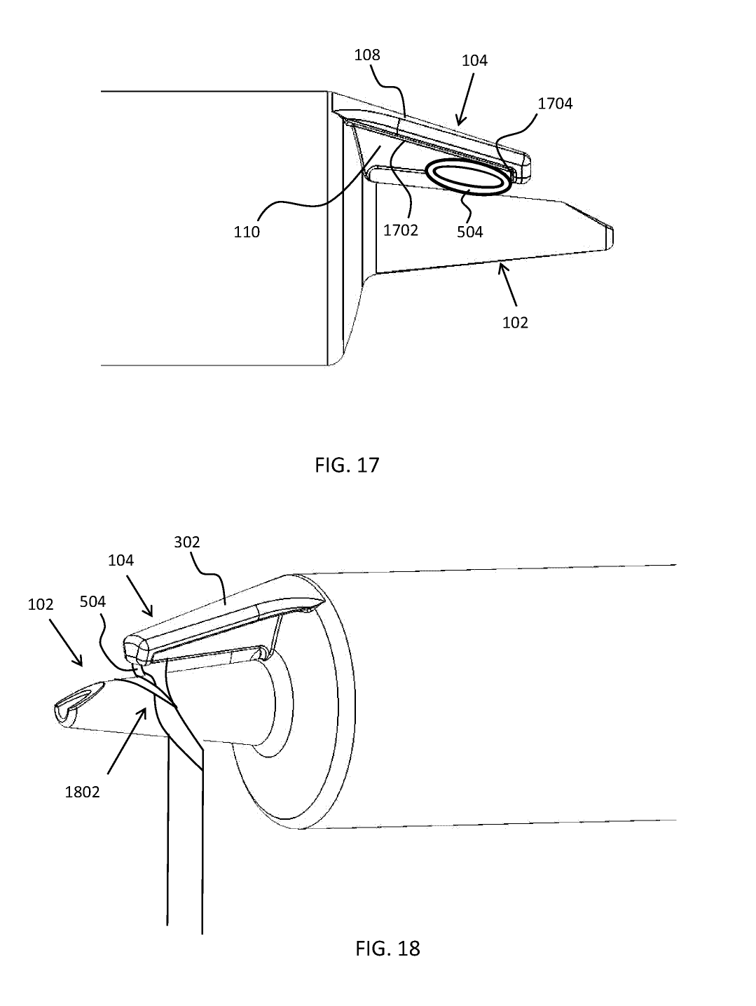

FIG. 17 provides an elevational partial view of the inventive pump 100, which shows the lip 504 of the balloon trapped on a back side of the channel 114 opposite the majority of the body 502 of the balloon 500. Because the first portion 108 of the neck-engaging extension 104 has a dimension W2 that exceeds a dimension W1 of the second portion 110 of the neck-engaging extension 104, the lip 504 is held securely and trapped by a side wall 1702 (defined by a first inside surface of the first portion 108), a front wall 1704 (defined by a second inside surface of the first portion 108), the planar lip supporting surface 304 of the second portion 110, and the outer peripheral surface of the nozzle 102. Recall that the sidewall 1702, the front wall 1704, the planar lip supporting surface 304, and the outer peripheral surface of the nozzle 102 define the recessed lip engagement compartment 202 illustrated in FIG. 2. It is this compartment 202 that traps the lip 504 and mouth of the balloon 500. The term “traps,” as used herein, is intended to mean a securing of the lip 504 of the balloon 500, so that a sufficient force must be applied to the lip 504 to allow it to overcome and move beyond the physical barriers, i.e., the sidewall 1702, the front wall 1704, the planar lip supporting surface 304, and the outer peripheral surface of the nozzle 102, keeping it in a secure position. This force is more than a force that allows a balloon to simply slide along a flat surface.

In a further step 1910, shown in FIG. 18, the neck 502 of the balloon is removed from the neck-engaging extension 104. This can be accomplished by, for example, either pulling on the body of the balloon in a direction away from the pump or pushing the portion of the neck 502 that sits atop the smooth peripheral surface 302 of the neck-engaging extension 104 in a distal direction. As FIG. 18 shows, when the neck 502 is pushed off of the neck-engaging extension 104, the neck 502 is pulled tightly against the nozzle 102 and traps the lip 504. At this point, the end of the balloon is already in a type of a loosely-tied knot 1802.

In step 1912, further force is applied to the body of the balloon, which causes the knot 1802 to become separated from the distal end of the nozzle 102. Because the lip 504 is trapped within the recessed lip engagement compartment 202 (not visible in this view), there is a resistance applied to lip 504 as the knot is removed from the nozzle 102. This resistance advantageously causes the knot 1802 to be pulled tightly as the lip 504 removes itself from the recessed lip engagement compartment 202. The process ends at step 1914.

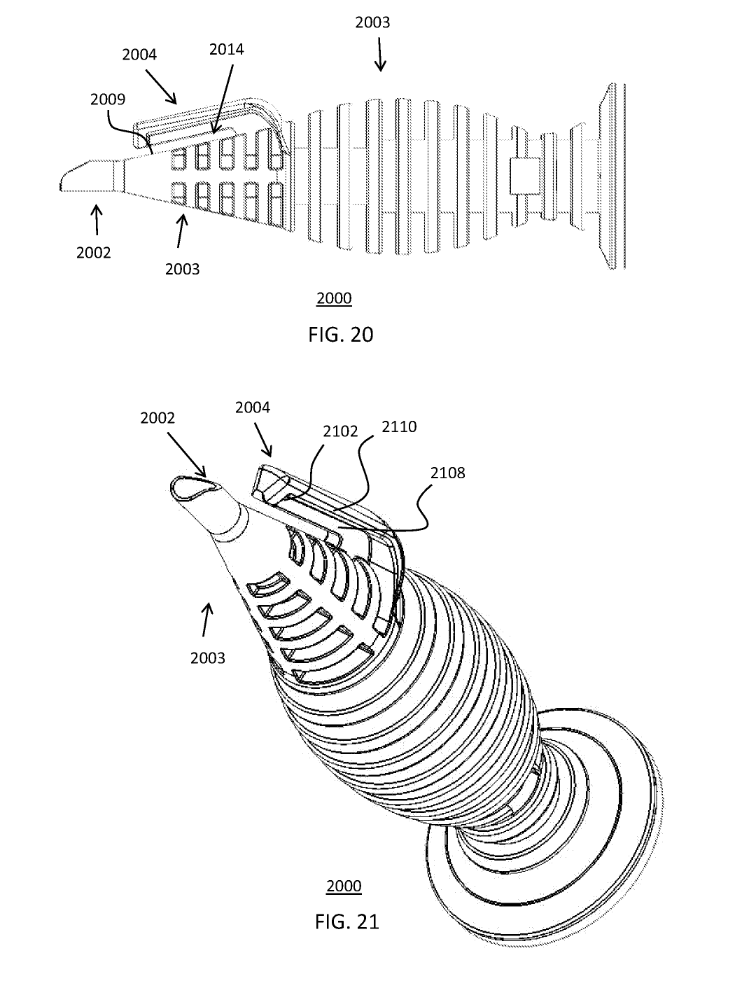

FIGS. 20 and 21 provide views of an additional embodiment of the present invention. The elements shown in FIGS. 20 and 21, although shaped slightly different than those shown in FIGS. 1-18, are at least equally well suited for performing balloon inflation and assisting with balloon-neck knot tying. More specifically, the inventive balloon-tying pump nozzle 2000 shown in FIG. 20 includes an elongated pump nozzle 2002 defining an air passageway adapted for transporting air between a non-illustrated air-collection chamber to the environment. By placing the elongated pump nozzle 2002 within the neck of a balloon, air that exits the air-collection chamber through the elongated pump nozzle 2002 is directed into and is contained by the balloon.

As FIG. 20 shows, the elongated pump nozzle 2000 has a general ergonomic shape with a region 2003 shaped to conform to a user's hand. The elongated pump nozzle 2000 also has a conically-shaped knot-tying region 2003 and a tubular inflation region 2002 coupled to the conically-shaped knot-tying region 2003. Although FIGS. 20 and 21 illustrate ergonomic shapes, these particular shapes are merely exemplary and are in no way required by the present invention.

Furthermore, FIG. 20 also shows an inventive neck-engaging extension 2004 adjacent to the conically-shape knot-tying region 2003. The neck-engaging extension 2004 extends in a direction that is substantially parallel to the outer surface 2009 of the conically-shaped knot-tying region 2003 with a channel 2014 being defined there between. The channel 2014, defined by the neck-engaging extension 2004 and the conically-shape knot-tying region 2003, is, preferably, of sufficient size to allow the neck 502 of the balloon 500, shown in FIG. 5, to fit within the channel 2014, but small enough to capture and hold the lip 504 of the balloon 500 on one side thereof.

With reference to the perspective view of FIG. 21, it can be seen that the neck-engaging extension 2004 has a particular shape that is conducive to holding a balloon during tying. This shape is defined, in the embodiment shown in FIGS. 20 and 21, by a first portion 2108 and a second portion 2110 that is physically coupled to the first portion 2108 in a T-type configuration, where the second portion 2110 is disposed between the conically-shape knot-tying region 2003 and the first portion 2108. The neck-engaging extension 2004 provides a front wall 2102 that provides resistance to the lip 504 of the balloon 500 when the balloon 500 is in a tied position, such as that shown in FIG. 18, and is being removed from the conically-shape knot-tying region 2003 and the tubular inflation region 2002.

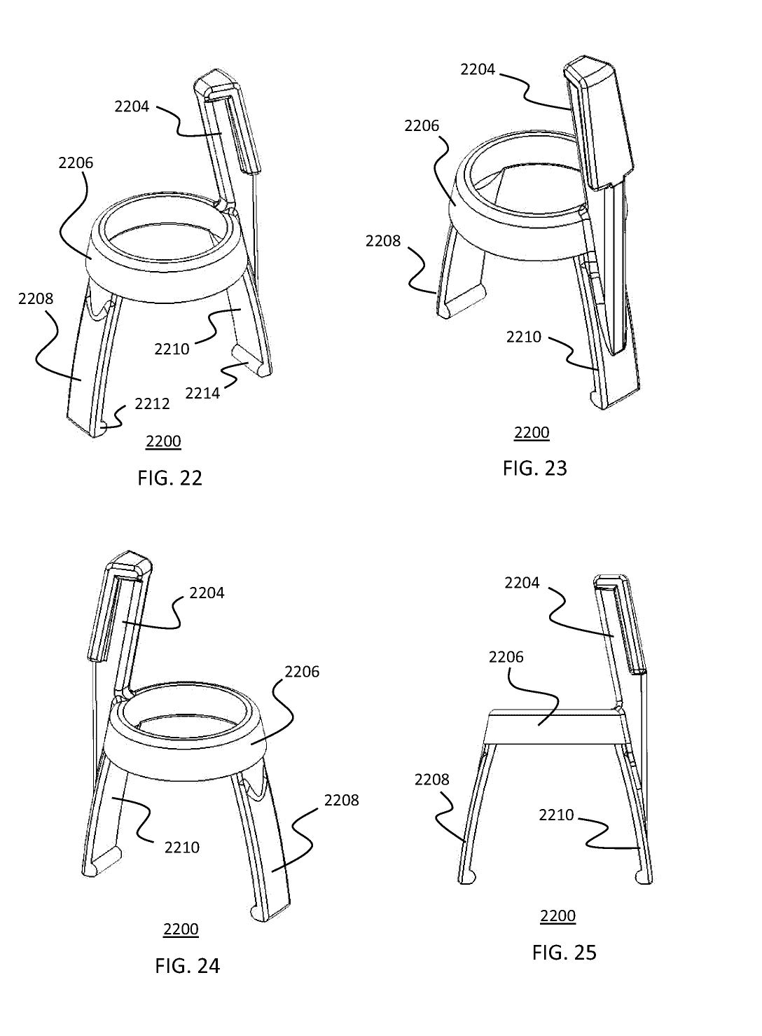

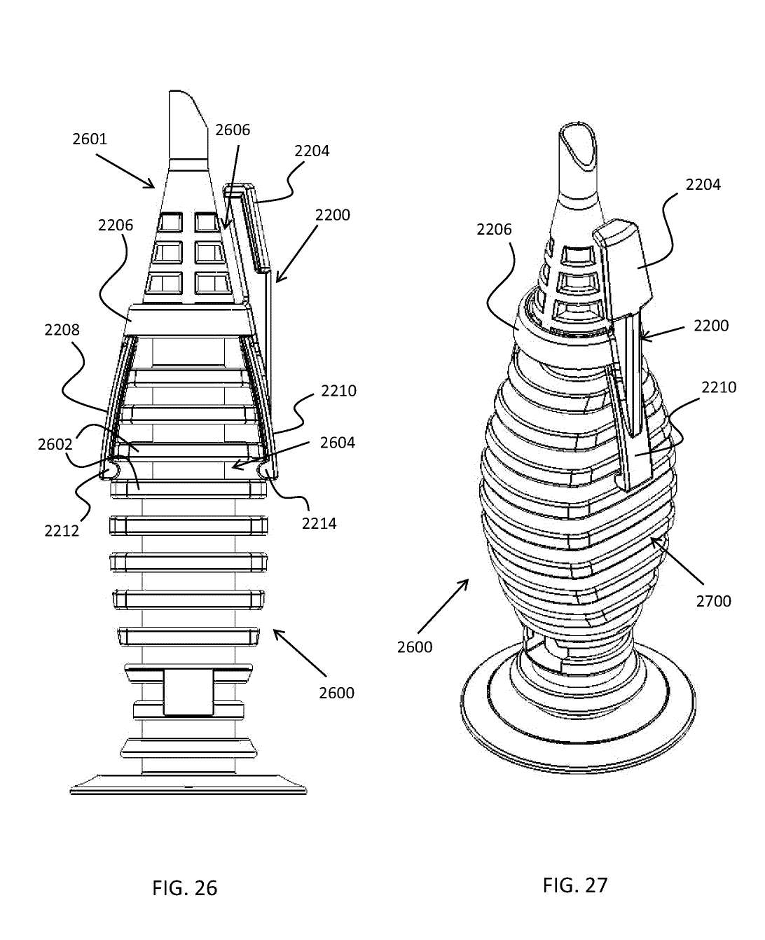

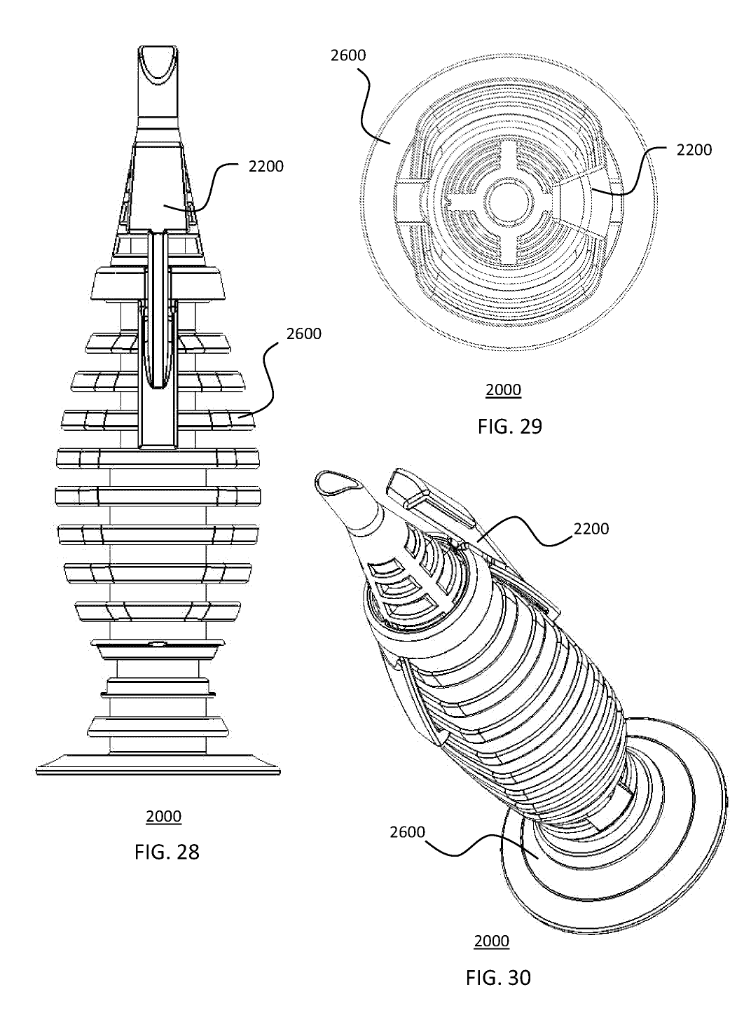

In accordance with a further embodiment, the present invention provides, as shown in FIGS. 22-25, a knot-tying accessory 2200 that is removably couplable to, as will be shown in FIGS. 26-30, an air-delivery nozzle. The couplable knot-tying accessory 2200 is advantageous in that it can be coupled to a standard air pump when desired and can remain off of the pump when not needed. In addition the couplable knot-tying accessory 2200 allows manufacturers to offer a standard air pump to the public at a lower cost while allowing those interested in a pump with a knot-tying feature to purchase the accessory and add it to the pump whenever needed.

Looking still to FIGS. 22-25, it can be seen that the knot-tying accessory 2200 includes a neck-engaging extension 2204 coupled to a securing ring 2206 and a pair of attachment legs 2208, 2210. In the particular embodiment shown in FIGS. 22-25 each of the attachment legs 2208, 2210 includes a protrusion 2212, 2214, respectively. Although not necessary, the protrusions 2212, 2214 provide for securing engagement with particular air-delivery nozzles. In accordance with an embodiment of the present invention, the attachment legs 2208, 2210 are of a material and a thickness that allows them to flex slightly in a direction away from each other. This flexible movement advantageously allows the knot-tying accessory 2200 to be removably coupled to the air-delivery nozzle.

Referring now to FIGS. 26-30, the knot-tying accessory 2200 is shown in coupled engagement with an air-delivery nozzle 2600. The coupling takes place by inserting a portion of the elongated air-delivery nozzle 2600 into the securing ring 2206 until the securing ring 2206 seats upon a distal end of the air-delivery nozzle 2600. In the particular embodiment shown, the air-delivery nozzle 2600 is provided with a plurality of ribs 2602. Each rib 2602 is separated by a space 2604. Once inserted upon the air-delivery nozzle 2600, the attachment legs 2208, 2210, in their natural resting position, places the protrusions 2212, 2214 within one of the spaces 2604 between a pair of ribs 2602. The mating between the protrusions 2212, 2214 and the ribs 2602 prevents the knot-tying accessory 2200 from becoming easily disconnected from the air-delivery nozzle 2600.

Once coupled to the air-delivery nozzle 2600, the neck-engaging extension 2204 extends in a direction that is substantially parallel to the elongated nozzle 2601 with a channel 2606 there between. In accordance with an embodiment of the present invention, the channel 2606, defined by the neck-engaging extension 2204 and the elongated nozzle 2601, is of sufficient size to allow a neck 502 of a balloon 500, shown in FIG. 5, to fit within the channel 2606, but small enough to inhibit a lip 504 of the balloon 500 from passing from one to the other side thereof. It is envisioned that the neck-engaging extension 2204 of the knot-tying accessory 2200 shares all of the physical features of the neck-engaging extension 104 described above.

In addition, as shown in FIG. 27, the air-delivery nozzle 2600 includes a substantially flat side 2700. The substantially flat side 2700 prevents one of the legs 2210 from rotating with respect to the air-delivery nozzle 2600. Advantageously, during a knot-tying process, the knot-tying accessory 2200 will remain stationary and not rotate around the air-delivery nozzle 2600, thus providing stability for the person tying the knot.

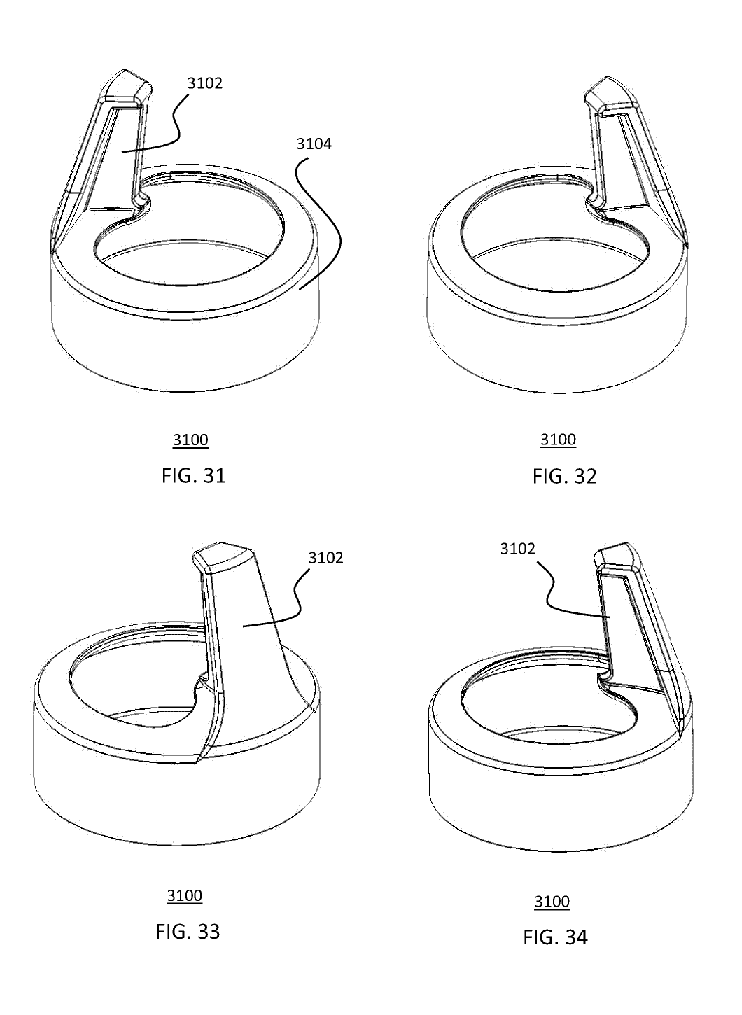

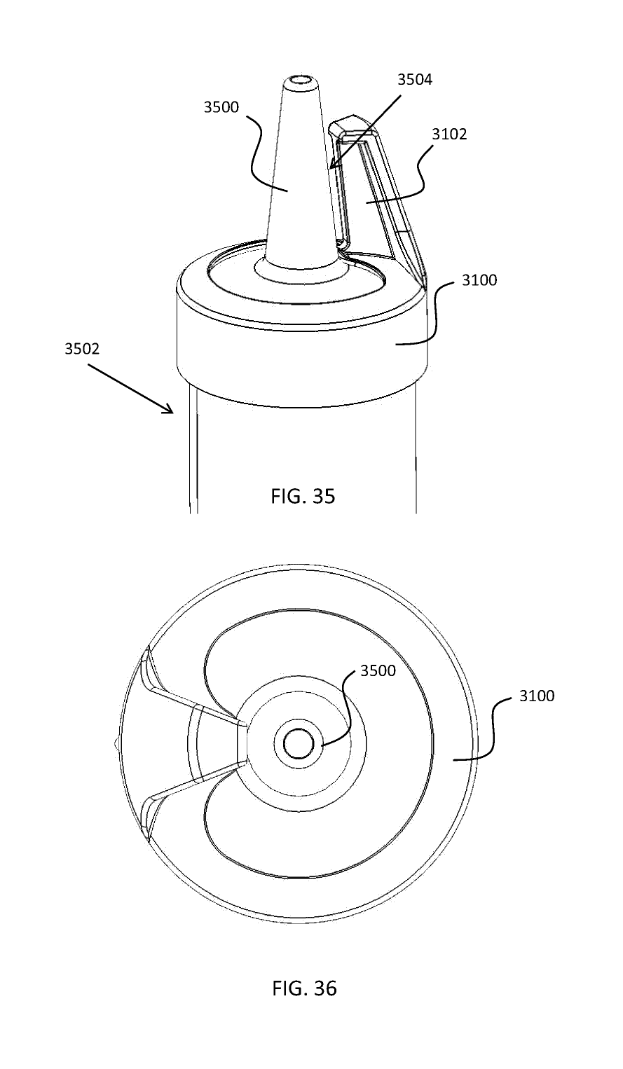

In yet a further embodiment, a knot-tying accessory 3100 can have the form shown in FIGS. 31-34. In this embodiment, the knot-tying accessory 3100 includes a neck-engaging extension 3102 coupled to a securing ring 3104. As shown in FIGS. 35 and 36, the knot-tying accessory 3100 can be coupled to an air-delivery nozzle 3500 of an air pump 3502. The coupling takes place by inserting a portion of the elongated air-delivery nozzle 3500 into the securing ring 3100 until the securing ring 3100 seats upon a distal end of the air pump 3502.

Once coupled to the air-delivery nozzle 3500, the neck-engaging extension 3102 extends in a direction that is substantially parallel to the elongated nozzle 3500 with a channel 3504 there between. In accordance with an embodiment of the present invention, the channel 3504 defined by the neck-engaging extension 3102 is of sufficient size to allow a neck 502 of a balloon 500, shown in FIG. 5, to fit within the channel 3504, but small enough to inhibit a lip 504 of the balloon 500 from passing from one to the other side thereof. It is envisioned that the neck-engaging extension 3102 of the knot-tying accessory 3100 shares all of the physical features of the neck-engaging extension 104 described above, but with the added advantage of being removable.

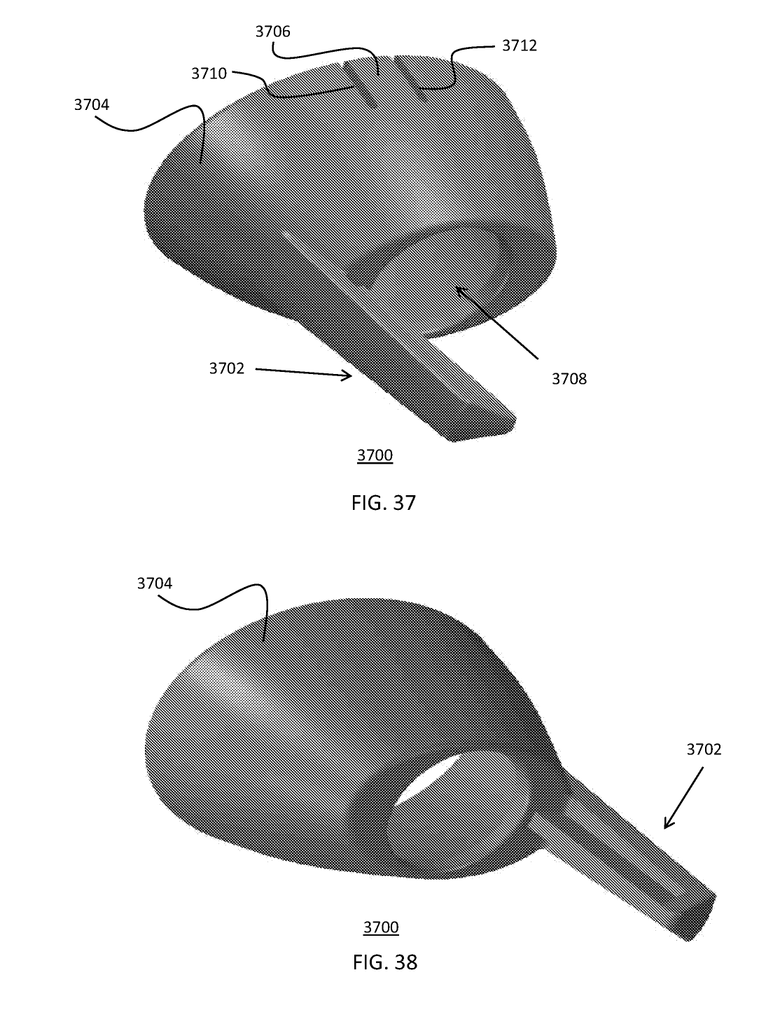

In an additional embodiment, a knot-tying accessory 3700 can have the form shown in FIGS. 37 and 38. In this embodiment, the knot-tying accessory 3700 includes a neck-engaging extension 3702 coupled to a securing body 3704. The knot-tying accessory 3700 can be coupled to an air-delivery nozzle, such as air-delivery nozzle 2600 shown in FIG. 26. The coupling takes place by inserting a portion of the elongated air-delivery nozzle 2600 into an aperture 3708 of the securing body 3708 until the securing body 3708 seats upon a distal end of the air-delivery nozzle 2600.

Once coupled to the air-delivery nozzle 2600, the neck-engaging extension 3702 extends in a direction that is substantially parallel to the elongated air-delivery nozzle 2600 with a channel there between. In accordance with an embodiment of the present invention, the channel defined by the neck-engaging extension 3702 is of sufficient size to allow a neck 502 of a balloon 500, shown in FIG. 5, to fit within the channel, but small enough to inhibit a lip 504 of the balloon 500 from passing from one to the other side thereof. It is envisioned that the neck-engaging extension 3702 of the knot-tying accessory 3700 shares all of the physical features of the neck-engaging extension 104 described above, but with the added advantage of being removable.

In addition, as shown in FIG. 37, the knot-tying accessory 3700 includes a clasp 3706 that helps couple the knot-tying accessory 3700 to the body of the pump. In particular, the clasp 3706 is defined by a pair of grooves 3710, 3712 on opposing sides of the clasp. The grooves 3710, 3712 allow the clasp to flex slightly when pressure is applied. Although not visible in the figures, clasp 3706 includes a raised area on its inner surface (opposite the exterior surface shown in FIG. 37). When installed on an air-delivery nozzle, such as air-delivery nozzle 2600 shown in FIG. 26, the normal resting position of the clasp 3706 places the inner raised area within the gap 2604 between the ribs 2602. The raised area, in combination with the clasp's natural spring tension keeping it in the position shown in FIG. 37, allows the knot-tying accessory 3700 to remain in place on the air-delivery nozzle 2600.

An inventive knot-tying nozzle has been disclosed that, as should now be clear, provides a balloon-tying process 1900 where the user's hand never needs to be separated from the inventive pump nozzle 100, 2000. This device and process obviates the prior-art need for setting the pump down or otherwise stowing it so that the user has both hands free to tie a knot in the balloon. The present invention also obviates the need for stretching the rubber around the user's fingers, thereby eliminating the painful pressure associated with prior-art knot-tying methods. Therefore, embodiments of the present invention make tying knots in balloons comfortable, easy, and fast. In addition, the inventive nozzle enjoys a low-profile shape, making the inventive device easy to store and transport.

What is claimed is:

1. A balloon-tying pump nozzle comprising:
an elongated pump nozzle defining an air passageway adapted for communicating air between an air-collection chamber of an air pump and the environment; and
a balloon-neck-engaging extension adjacent to and extending substantially parallel to the elongated pump nozzle, the balloon-neck-engaging extension and the elongated pump nozzle defining a channel therebetween, the channel being sized to accept a neck of a standard party balloon therein and inhibit a lip of the standard party balloon from passing therebetween.

2. The balloon-tying pump nozzle according to claim 1, wherein the neck-engaging extension further comprises:
a first portion; and
a second portion:
physically coupled to the first portion;
located between the elongated pump nozzle and the first portion; and
having a dimension that is less than a dimension of the first portion, thereby forming a balloon-lip-engagement compartment.

3. The balloon-tying pump nozzle according to claim 2, wherein:
a difference between the dimension of the first portion of the neck-engaging extension and the dimension of the second portion of the neck-engaging extension is at least substantially equal to a height dimension of a lip of a standard balloon.

4. The balloon-tying pump nozzle according to claim 2, wherein the balloon-lip-engagement compartment is defined by:
the first portion of the neck-engaging extension, the second portion of the neck-engaging extension, and an outside surface of the elongated pump nozzle.

5. The balloon-tying pump nozzle according to claim 2, wherein:
the second portion of the neck-engaging extension is substantially centered upon the first portion of the neck-engaging extension, thereby defining the balloon-lip-engagement compartment on a first side of the second portion of the neck-engaging extension and a second balloon-lip-engagement compartment on a second side of the neck-engaging extension.

6. The balloon-tying pump nozzle according to claim 2, wherein:
the first portion of the neck-engaging extension defines an outer neck-wrapping peripheral surface.

7. The balloon-tying pump nozzle according to claim 2, wherein:
the second portion of the neck-engaging extension defines a generally planar balloon lip supporting surface.

8. The balloon-tying pump nozzle according to claim 1, wherein:
the nozzle defines a generally conical outer shape.

9. The balloon-tying pump nozzle according to claim 1, wherein the neck-engaging extension is removably coupled to the air pump.

10. An air pump comprising:
an air-collecting chamber;
an air nozzle extending from and in fluid communication with an interior of the air-collecting chamber; and
a balloon-neck-engaging extension adjacent the nozzle and physically coupled to at least one of the air collecting chamber and the nozzle, the balloon-neck-engaging extension and the nozzle forming a balloon neck-engaging channel therebetween, the balloon neck-engaging channel being sized to accept a neck of a standard party balloon therein while inhibiting a lip of the standard party balloon from passing therebetween.

11. The air pump according to claim 10, wherein the balloon-neck-engaging extension further comprises:
a first portion; and
a second portion:
physically coupled to the first portion;
located between the air nozzle and the first portion; and
having a dimension that is less than a dimension of the first portion, thereby forming a balloon-lip-engagement compartment.

12. The air pump according to claim 11, wherein:
a difference between the dimension of the first portion of the balloon-neck-engaging extension and the dimension of the second portion of the balloon-neck-engaging extension is at least substantially equal to a height dimension of a lip of a standard balloon.

13. The air pump according to claim 11, wherein the balloon-lip-engagement compartment is defined by:
the first portion of the balloon-neck-engaging extension, the second portion of the balloon-neck-engaging extension, and an outside surface of the air nozzle.

14. The air pump according to claim 11, wherein:
the second portion of the balloon-neck-engaging extension is substantially centered upon the first portion of the balloon-neck-engaging extension, thereby defining the balloon-lip-engagement compartment on a first side of the second portion of the balloon-neck-engaging extension and a second balloon-lip-engagement compartment on a second side of the balloon-neck-engaging extension.

15. The air pump according to claim 11, wherein:
the first portion of the balloon-neck-engaging extension defines an outer neck-wrapping peripheral surface.

16. The air pump according to claim 11, wherein:
the second portion of the balloon-neck-engaging extension defines a generally planar balloon lip supporting surface.

17. The air pump according to claim 10, wherein:
the air nozzle defines a generally conical outer shape.

18. A method for sealing an inflated balloon, the method comprising:
providing a balloon-tying pump nozzle comprising:
an air nozzle defining an air passageway adapted for communicating air between an air-collection chamber of an air pump and the environment; and
a balloon-neck-engaging extension adjacent to and extending substantially parallel to the air nozzle, the balloon-neck-engaging extension and the air nozzle defining a channel therebetween, wherein the channel is sized to accept a neck of a standard party balloon therein while inhibiting a lip of the standard party balloon from passing therebetween;
placing a neck of a balloon adjacent the air nozzle and the balloon-neck-engaging extension so that the balloon is on a first side of the air nozzle and the balloon-neck-engaging extension;
securing a portion of the neck of the balloon with reference to the air nozzle;
manipulating the balloon so that at least a portion of the neck of the balloon is wrapped completely around both the air nozzle and the balloon-neck-engaging extension;
inserting a portion of the neck within the channel so that the lip of the balloon is on a second side of the air nozzle and the balloon-neck-engaging extension; and
removing the balloon from both the balloon-neck-engaging extension and the air nozzle, thereby causing the balloon to form a knot.

19. The method according to claim 18, wherein the removing step comprises:
pulling one of the neck and a body of the balloon away from the balloon-tying pump nozzle in a distal direction.

20. The method according to claim 18, wherein the removing step comprises:
placing a force upon a portion of the neck that rests upon an exterior surface of the balloon-neck-engaging extension in a distal direction.
